(19) United States
(12) Patent Application Publication
(10) Pub. No.: US 2026/0157350 A1
(43) Pub. Date: Jun. 11, 2026

(54) Bird Feeder

(71) Applicant: NETVUE TECHNOLOGIES CO., LTD., SHENZHEN (CN)

(72) Inventors: Rui Zhang, SHENZHEN (CN); Youle Hu, SHENZHEN (CN)

(21) Appl. No.: 19/412,985

(22) Filed: Dec. 9, 2025

(30) Foreign Application Priority Data
Dec. 11, 2024 (CN) 202423055966.3
Dec. 11, 2024 (CN) 202423061396.9
Dec. 11, 2024 (CN) 202423061443.X
Dec. 11, 2024 (CN) 202423062273.7
Dec. 11, 2024 (CN) 202423063362.3
Dec. 11, 2024 (CN) 202423063383.5
Dec. 11, 2024 (CN) 202423070278.4

(51) Int. Cl. A01K 39/01; A01K 39/012; F16M 13/02; G03B 29/00; H02S 20/23

(52) U.S. Cl. CPC A01K 39/0106; A01K 39/012; F16M 13/02; G03B 29/00; H02S 20/23

(57) ABSTRACT

The present disclosure relating to the technical field of bird feeders, provides a bird feeder comprising a feed bin assembly, wherein the feed bin assembly comprises a bin body which is a metal bin body, an installation groove for accommodating and assembling a camera assembly is formed in the bin body; and a least one signal window penetrating through the bin body and the installation groove is opened at the part of the bin body where the installation groove is formed.

### CROSS-REFERENCE TO RELATED APPLICATIONS

This application claims priority to the Chinese Patent Applications filed with the China National Intellectual Property Administration on Dec. 11, 2024, namely application No. 202423061396.9, application No. 202423061443.X, application No. 202423062273.7, application No. 202423063383.5, application No. 202423055966.3, application No. 202423063362.3, and application No. 202423070278.4, the entire contents or partial contents of which are incorporated herein by reference.

### TECHNICAL FIELD

The present disclosure relates to the technical field of bird feeders, and in particular, relates to a bird feeder.

### BACKGROUND

Bird feeders are a kind of specialized devices designed for bird feeding and observation. Users place food in bird feeders to attract birds, images of which are then captured by cameras or other camera assemblies and wirelessly transmitted to users, so that users can watch birds remotely in real time or regularly. Thus, bird feeders are highly popular among bird lovers or scientific researchers.

Most bird feeders are installed outdoors and have a certain volume. In order to ensure the firmness and durability of bird feeders during transportation and usage, and prolong their service life, metal materials are usually adopted to ensure that bird feeders can withstand the complex conditions encountered during transportation and in outdoor environments.

### SUMMARY

A primary objective of embodiments of the present disclosure is to a bird feeder, which mitigate signal shielding of a camera assembly by a metal bin body, thereby preventing the camera assembly from failing to communicate with the outside world.

Accordingly, some embodiments of the present disclosure provide a bird feeder which comprises a feed bin assembly, wherein the feed bin assembly comprises a bin body which is a metal bin body, an installation groove for accommodating and assembling a camera assembly is formed on the bin body; and a least one signal window penetrating through the bin body and the installation groove is opened at the part of the bin body where the installation groove is formed.

Optionally, at least one of a part of the back panel of the bin body that is opposite to the bottom of the installation groove and a part of the bin body surrounding the peripheral surface of the installation groove is provided with the signal window.

Optionally, the front panel or the side panel of the bin body is provided with the signal window.

Optionally, the feed bin assembly further comprises a non-metallic light-transmissive or opaque window baffle, and the window baffle is arranged on the bin body to shield the signal window.

Optionally, the window baffle is installed on the inner wall of the bin body, and the bin body is provided with a fixing member to fix the window baffle to the signal window.

Optionally, the fixing member comprises a first fixing arm, a bending arm and a second fixing arm, wherein the first fixing arm is fixed on the inner wall of the metal bin body, one end of the bending arm is connected with the first fixing arm, the other end of the bending arm is connected with the second fixing arm, and the first fixing arm, the bending arm and the second fixing arm together form a first fixing slot into which the window baffle is inserted.

Optionally, the feed bin assembly further comprises a sealing layer, and the sealing layer is arranged between the window baffle and the metal bin body to seal the window baffle and the metal bin body.

Optionally, the sealing layer is arranged around the signal window, and the sealing layer is bonded to the periphery of the window baffle.

Optionally, the signal window may be a large through hole with a required size, or it may be composed of a plurality of small through holes.

Optionally, the bird feeder further comprises a feeding tray assembly made of metal, wherein the feeding tray assembly is installed at the feed outlet end of the feed bin assembly.

### BRIEF DESCRIPTION OF THE DRAWINGS

In order to explain the technical solutions in the embodiments of the present application more clearly, attached drawings needed in the description of the embodiments of the present application will be briefly introduced below. Obviously, the attached drawings described below are only some embodiments of the present application, and other drawings can be obtained by those of ordinary skill in the art according to these drawings without making creative efforts.

FIG. 1 is a schematic view of the exploded structure of a bird feeder provided according to an embodiment of the present disclosure.

FIG. 2 is a schematic view of the assembled structure of a bird feeder provided according to an embodiment of the present disclosure.

FIG. 3 is a schematic structural diagram of a feeding tray assembly and a perch assembly of a bird feeder provided according to an embodiment of the present disclosure.

FIG. 4 is a schematic view of the cross-sectional structure of a bird feeder provided according to an embodiment of the present disclosure.

FIG. 5 is a partial enlarged view of part A in FIG. 4.

FIG. 6 is a schematic structural diagram of a snap-fit assembly provided according to an embodiment of the present disclosure.

FIG. 7 is a schematic structural diagram of a solar panel provided according to an embodiment of the present disclosure.

FIG. 8 is a schematic view of a bird feeder provided according to an embodiment of the present disclosure when viewed from another perspective.

FIG. 9 is a partial enlarged view of part B in FIG. 4.

FIG. 10 is a schematic view illustrating the plug-in connection between the connectors of the camera assembly and the power supply assembly according to an embodiment of the present disclosure.

FIG. 11 is a schematic structural diagram of a material guide provided according to an embodiment of the present disclosure.

FIG. 12 is a partial enlarged view of part C in FIG. 11.

FIG. 13 is a schematic view of the exploded structure of yet another bird feeder provided according to an embodiment of the present disclosure.

FIG. 14 is a cross-sectional enlarged schematic view of a standing rod provided according to an embodiment of the present disclosure.

FIG. 15 is a schematic structural diagram of an anti-leakage net provided according to an embodiment of the present disclosure.

Reference numerals and denotations thereof:
1000—Bird feeder;
1—Feed bin assembly; 11—Bin body; 111—Feed cavity; 112—Feed outlet; 113—Signal window; 114—Fixing member; 1141—First fixing arm; 1142—Bending arm; 1143—Second fixing arm; 114a—First fixing slot; 115—Installation groove; 116—Inner frame body; 12—Window baffle; 13—Sealing layer; 14—Accommodating groove; 141—First wire through hole; 142—Avoidance groove; 15—Wire duct; 16—Second wire through hole; 17—Retaining hook; 19—Top cover; 191—Rotating connector; 1911—Rotating shaft; 1912—Rotating sleeve; 192—Stabilizing connector; 1a-Material guide; 1a1—Supporting part; 1a2—Inclined part; 1a21—Plug-in part; 1b-Step portion; 1c—Snap-fit hole;
2—Feeding tray assembly; 21—Feeding trough; 211—Drainage hole; 212—Plug-in hole; 22—Threaded groove;
3—Perch assembly; 31—Rod-like structure; 311—Standing rod; 3111—Engagement lug; 312—Distance adjusting member; 3121—Connecting rod; 3121a—Engagement slot; 3121b—Sliding slot; 3122—First gasket; 3123—Second gasket; 32—Locking piece; 321—Anti-slip texture; 322—Threaded part; 33—Thermal insulation member;
4—Camera assembly; 41—Second connector;
5—Camera assembling component; 51—First magnetic attraction piece; 52—Second magnetic attraction piece; 53—Snap-fit assembly; 531—Elastic snap-fit member; 5311—Mounting arm; 5312—Connecting arm; 5313—Elastic arm; 5313a—Retaining groove; 5314—Guiding arm;
6—Power supply assembly; 6a—Solar panels; 61—Wire; 6a1—Panel body; 6a2—Controller; 62—Thermally conductive adhesive layer; 63—First connector;
7—Anti-leakage net; 71—Leakage hole; 71a—First feeding port; 71b—Second feeding port; 72—Snap-fit portion;
8—Locking assembly; 81—Locking piece; 811—Locking part; 812—Handle; 82—Mounting piece;
9—Guiding member;
S1—Feeding zone; S2—Avoidance zone; S21—Perch-forbidden zone; S22—Optional zone.

### DETAILED DESCRIPTION

In order to facilitate the understanding of the present disclosure, the present disclosure will be illustrated in more detail with reference to the attached drawings and specific embodiments hereinafter. It shall be noted that when an element is said to be “fixed to” another element, it may be directly on the other element, or there may be one or more intervening elements therebetween. When an element is said to be “connected” to another element, it may be directly connected to the other element, or there may be one or more intervening elements therebetween. The terms “vertical”, “horizontal”, “left” and “right” and similar expressions used in this specification are for illustrative purposes only.

Unless otherwise defined, all technical and scientific terms used in this specification have the same meanings as commonly understood by those skilled in the art of the present disclosure. The terms used in the specification of the present disclosure are only for the purpose of describing specific embodiments, and are not intended to limit the present disclosure. The term “and/or” used in this specification comprises any and all combinations of one or more associated items listed.

Bird feeders are a kind of specialized devices designed for bird feeding and observation. Users place food in bird feeders to attract birds, images of which are then captured by cameras or other camera assemblies and wirelessly transmitted to users, so that users can watch birds remotely in real time or regularly.

To ensure bird feeders can withstand the complex conditions encountered during transportation and in outdoor environments, metal materials are usually adopted. However, due to the electrostatic shielding effect of the metal casing, the signal of data transmission by the camera assembly to the outside world are severely interfered with, and in some cases, the wireless signals for communication between the camera assembly and the external environment can even be completely blocked. This significantly impacts the performance and user experience of the bird feeders.

To solve the aforementioned problems, the present disclosure provides a bird feeder, wherein at least one signal window is opened on a metal bin body for a camera assembly, thereby mitigating signal shielding of the camera assembly by the metal bin body, preventing the camera assembly from failing to communicate with the outside world, and ensuring the structural strength and durability of the bird feeder.

Hereinafter, the specific structure and function of the bird feeder according to the present disclosure is described in detail.

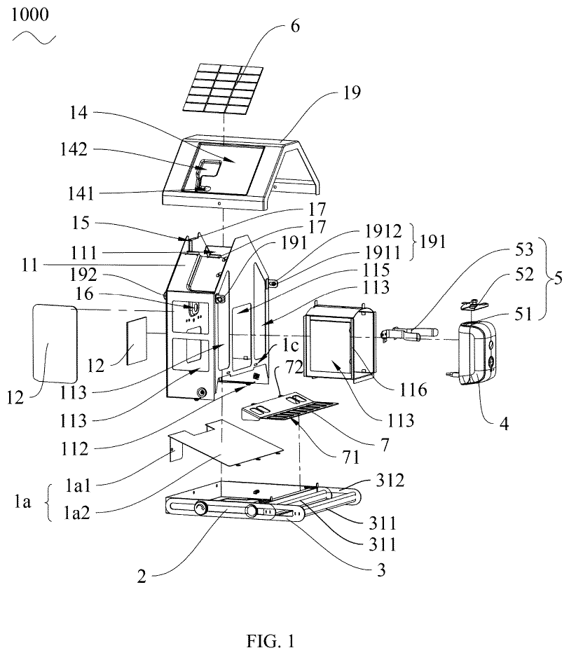

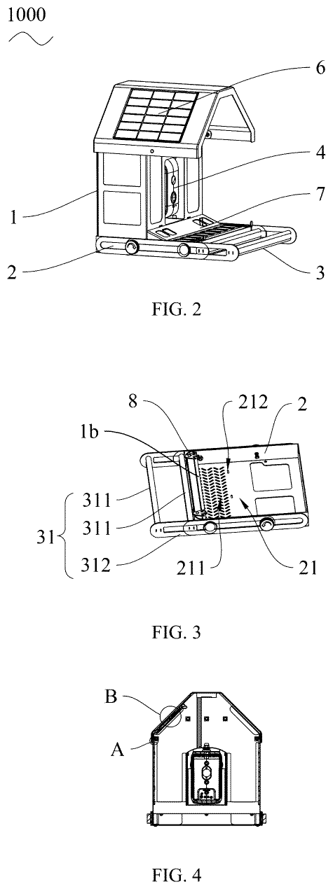

Referring to FIG. 1, FIG. 2 and FIG. 3, a bird feeder 1000 comprises a feed bin assembly 1, a feeding tray assembly 2, a perch assembly 3 and a camera assembly 4. Both the feeding tray assembly 2 and the camera assembly 4 can be arranged on the feed bin assembly 1. The feeding tray assembly 2 is arranged at the feed outlet end of the feed bin assembly 1 and receives the bird feed output from the feed bin assembly 1. The perch assembly 3 is arranged on the feeding tray assembly 2 for birds to stand on. The camera assembly 4 is fixedly or detachably assembled on the feed bin assembly 1, and the camera assembly 4 is oriented towards the feeding tray assembly 2 so as to shoot and collect images of birds when they appear in the shooting range. Further speaking, the camera assembly 4 can also communicate with external devices and send the collected bird images to other devices for users to view on other devices. For example, when birds appear on the feeding tray assembly 2 or the perch assembly 3 to eat or perch, the camera assembly 4 captures and collects images of birds within the shooting range according to a preset acquisition mode, and wirelessly sends the images of birds to devices such as mobile phones and computers bound by users for real-time or regular viewing, thus providing users with excellent experience of remote and intelligent bird watching.

Specifically, the feed bin assembly 1 comprises a bin body 11, and the bin body 11 is provided with a feed cavity 111 which has a feed inlet and a feed outlet 112. The feed cavity 111 is used for storing bird feed, and the feed inlet and the feed outlet 112 are used for material communication between the feed cavity 111 and the outside world, such as feed replenishment and discharge. The feeding tray assembly 2 is installed at the feed outlet end of the bin body 11. The feeding tray assembly 2 is provided with a feeding trough 21, and the feeding trough 21 is connected with the feed cavity 111 through the feed outlet 112. In this mode, the lower end of the feed bin assembly 1 is the feed outlet end, and the feed outlet 112 is located at the lower end of the feed bin assembly 1, so that the bird feed stored in the feed cavity 111 can be transported from the feed outlet 112 to the feeding trough 21 under the action of gravity. The perch assembly 3 is arranged on the feeding tray assembly 2, so that birds can stand on the perch assembly 3 for eating or perching. As shall be appreciated, the perch assembly 3 should be provided with a rod-like structure 31 which is convenient for the birds to grasp with their toes, so as to enhance the biocompatibility between the bird feeder and the birds. Moreover, the shooting distance between the camera assembly 4 and the birds is adjusted so that the camera assembly 4 can capture bird images meeting the predetermined requirements. The camera assembly 4 is assembled on the feed bin assembly 1 so as to capture images of birds perching or eating on the bird feeder 1000. The shooting range of the camera assembly 4 can cover at least part of the feeding trough 21, and can also cover the perch assembly 3, so as to ensure the comprehensive monitoring of birds eating or perching on the bird feeder 1000 and provide sufficient data support for related behavior and action research of birds. The camera assembly 4 can wirelessly receive and send signals to the outside world for communication, so that the captured images can be transmitted to the outside world regularly or in real time, e.g., so that the captured images can be transmitted to other terminals other than the bird feeder 1000 regularly or in real time, e.g., to mobile phones, PADs, computers or other terminals bound to the bird feeder 1000.

In some embodiments, referring to FIG. 3, the bottom of the feeding trough 21 is provided with a drainage hole 211, which is used to discharge the water that may accumulate in the feeding trough 21, so as to prevent the bird feed in the feeding trough 21 from being soaked for a long time and thus spoiling, thereby protecting the health of birds foraging here.

The materials used for the bird feeder 1000 include, but are not limited to, wood, plastics, metals, glass and the like, or a combination of a plurality of materials. When the overall structure of the bird feeder 1000 is made of metal, the structural strength of the bird feeder 1000 can be greatly improved, and thus the bird feeder has excellent properties such as being shock-resistant and durable. However, the metal casing of the bird feeder 1000 will have a shielding effect on signals received and transmitted by the camera assembly 4 inside the bird feeder 1000, which will affect the data transmission between the camera assembly 4 and the outside world and greatly reduce the performance and user experience of the bird feeder 1000.

Therefore, the present disclosure proposes a bird feeder 1000 made of metallic materials, or a combination of metallic and non-metallic materials, which solves the above-mentioned signal shielding problem on the premise of ensuring the structural strength and durability of the bird feeder 1000.

Referring to FIG. 1, the feed bin assembly 1 comprises a bin body 11, and the bin body 11 is formed with an installation groove 115 for accommodating and assembling a camera assembly 4. The bin body 11 is a metal bin body, that is, the feed bin assembly 1 comprises a metal bin body. At least one signal window 113 penetrating through the bin body 11 and the installation groove 115 is opened at the part of the bin body 11 where the installation groove 115 is formed. The signal window 113 may be a large through hole of a required size, or it may be composed of a plurality of small through holes, such as being mesh-shaped. Furthermore, an installation groove 115 is opened in the middle of the front face of the bin body 11 facing the shooting direction of the camera assembly 4. The feeding tray assembly 2 is also made of metal, which further ensures the structural strength of the bird feeder 1000.

Considering that the antenna of the camera assembly 4 is usually accommodated in the bottom of the installation groove 115, in one mode, the signal window 113 is opened at the position of the back panel of the bin body 11 that is opposite to the bottom of the installation groove 115, that is, a signal window 113 penetrating through the back panel of the bin body 11 is formed at the bottom of the installation groove 115.

Further speaking, a signal window 113 may also be opened at the part of the bin body 11 that surrounds the peripheral surface of the installation groove 115. That is, at least one of a part of the back panel of the bin body 11 that is opposite to the bottom of the installation groove 115 and a part of the bin body 11 surrounding the peripheral surface of the installation groove 115 is provided with the signal window 113.

In order to further weaken the signal shielding, the front panel or the side panel of the bin body 11 may also be provided with a signal window 113. The size and number of signal windows 113 on the front panel or the side panel can be maximized under the condition of satisfying the stable support of the bin body 11. That is, except for the necessary skeleton support, the rest of the front panel and side panel of the bin body 11 can all be designed as the signal windows 113.

Further speaking, the bin body 11 includes an inner frame body 116, and the above-mentioned installation groove 115 is formed by the inner frame body 116. The inner frame body 116 is opened with at least one signal window 113 penetrating through the bin body 11 and the installation groove 115.

In one mode, the signal window 113 is opened at the position of the back panel of the inner frame body 116 that is opposite to the bottom of the installation groove 115, that is, the signal window 113 penetrating through the back panel of the inner frame body 116 (that is, penetrating through the back panel of the bin body 11) is formed at the bottom of the installation groove 115. Furthermore, the peripheral panel of the inner frame body 116 may also be opened with a signal window 113. The inner frame body 116 and the bin body 11 may be integrally connected, or connected by splicing or clamping or the like.

Further speaking, the feed bin assembly 1 further comprises a non-metallic light-transmissive or opaque window baffle 12, and the window baffle 12 is arranged on the bin body 11 for shielding the signal window 113. While the arrangement of the signal window 113 ensures that the signal of the camera assembly 4 can be transmitted to the outside through the signal window 113, the arrangement of the window baffle 12 ensures that the feed bin is in a closed state, thus providing good protection for the bird feed.

As shall be appreciated, in order to ensure that the window baffle 12 does not affect the signal transmission and reception of the camera assembly 4, the window baffle 12 may be made of nonmetallic materials such as glass, plastics, wood boards or the like.

Further speaking, the window baffle 12 is made of light-transmissive nonmetallic materials, that is, the feed bin assembly 1 comprises a light-transmissive nonmetallic window baffle 12, so that users can observe the situation in the feed bin through the window baffle 12 by virtue of the light-transmissive characteristics of the window baffle 12, which is convenient for users to replenish or replace bird feed in time.

The window baffle 12 is arranged on the metal bin body 11 by methods such as, but not limited to, snap-fit connection, adhesive bonding, screw fastening or the like.

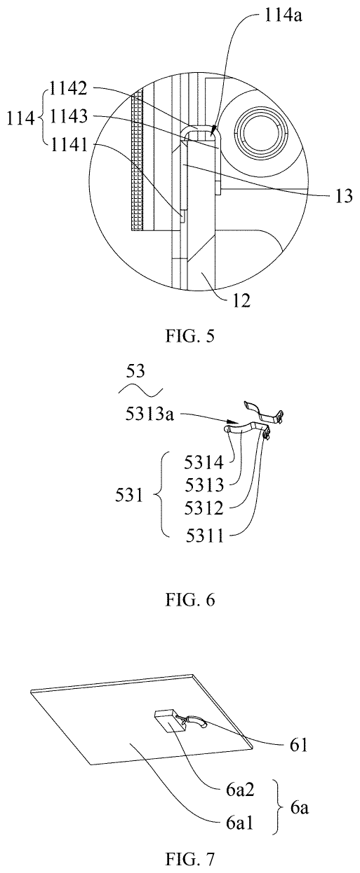

In some embodiments, referring to FIG. 4 and FIG. 5, the window baffle 12 is installed on the inner wall of the bin body 11. The window baffle 12 is installed via snap-fit connection. The bin body 11 is provided with a fixing member 114, and the fixing member 114 fixes the window baffle 12 to the signal window 113. The fixing member 114 is disposed around the signal window 113. The number of fixing members 114 is plural, and the plurality of fixing members 114 are arranged at intervals around the signal window 113 and are configured to fix all of the peripheral edges of the window baffle 12 to the metal bin body 11.

The fixing member 114 comprises a first fixing arm 1141, a bending arm 1142 and a second fixing arm 1143. The first fixing arm 1141 is fixed to the inner wall of the metal bin body 11 via fixing means including but not limited to welding, adhesive bonding, screw fastening or the like. Illustratively, in this embodiment, the first fixing arm 1141 is welded to the inner wall of the metal bin body 11. One end of the bending arm 1142 is connected to the first fixing arm 1141, the other end of the bending arm 1142 is connected to the second fixing arm 1143, and the first fixing arm 1141, the bending arm 1142 and the second fixing arm 1143 together form a first fixing slot 114a into which the window baffle 12 is inserted.

As shall be appreciated, the structure of the fixing member 114 is not limited to what described above, and the fixing member 114 can also adopt an elastic arm. For example, the bending arm 1142 is replaced by an elastic arm. The spacing between the first fixing arm 1141 and the second fixing arm 1143 is gradually increased in the direction from the opening to the bottom of the first fixing slot 114a, and when the window baffle 12 is inserted into the first fixing slot 114a, the first fixing arm 1141 and the second fixing arm 1143 together clamp the window baffle 12 to improve the stability of the window baffle 12 fixed by the fixing member 114.

In some embodiments, referring back to FIG. 5, the feed bin assembly 1 further comprises a sealing layer 13, which is arranged between the window baffle 12 and the metal bin body 11 to seal the window baffle 12 and the metal bin body 11. Further speaking, the sealing layer 13 is arranged around the signal window 113, and the sealing layer 13 is bonded to the periphery of the window baffle 12. The arrangement of the sealing layer 13 realizes the sealed connection between the window baffle 12 and the metal bin body 11, and prevents foreign matters such as external water vapor and dust from entering the feed cavity 111 through the gap between the window baffle 12 and the inner wall of the metal bin body 11.

As shall be appreciated, when the solution of fixing the periphery of the window baffle 12 to the metal bin body 11 by using a plurality of fixing members 114 is adopted, due to the thickness of the first fixing arm 1141 of the fixing member 114, a gap exists between the window baffle 12 and the inner wall of the metal bin body 11, and foreign substances such as external water vapor and dust will enter the interior of the feed cavity 111 through this gap. In this case, the window baffle 12 may be fixed with the metal bin body 11 by using the fixing members 114 in combination with the sealing layer 13.

In some embodiments, the number of signal windows 113 and window baffles 12 is plural. A window baffle 12 shields a signal window 113, or a window baffle 12 may shield a plurality of signal windows 113.

As shall be appreciated, the shape of the signal window 113 may be selected according to actual needs, including but not limited to rectangular, rounded rectangular, trapezoidal, circular or any irregular shapes, and this is not limited separately in this embodiment.

The camera assembly 4 of the existing bird feeder 1000 is generally arranged on the feed bin assembly 1 by screw fastening, but screw fastening involves the disassembly and assembly of screw fasteners during the disassembly and assembly of the camera assembly 4, and the operation steps are cumbersome and necessitate the use of external tools. Thus, the user can not complete the disassembly and assembly of the camera assembly 4 without external tools, which is both time and labor-consuming, and the operation is extremely inconvenient.

In order to facilitate the quick and convenient disassembly and assembly of the camera assembly 4, in this embodiment, referring back to FIG. 1, the bird feeder 1000 comprises a camera assembling component 5, which is used to detachably assemble the camera assembly 4 to the feed bin assembly 1 in a non-fastening manner, so that the camera assembly 4 can be conveniently assembled to and disassembled from the feed bin assembly 1. The camera assembling component 5 is disposed on at least one of the feed bin assembly 1 and the camera assembly 4. In order to ensure the stability of installation, the camera assembling component 5 detachably assembles the camera assembly 4 to the feed bin assembly 1 in a non-fastening manner in at least two dimensions. Further speaking, the feed bin assembly 1 comprises a bin body 11, and the bin body 11 is formed with an installation groove 115 for accommodating and assembling the camera assembly 4. The camera assembling component 5 is partially or completely installed in the installation groove 115.

Furthermore, the non-fastening detachable means may be at least one of magnetic attraction, snap-fit connection and hanging mounting. That is, the camera assembling component 5 is mounted by at least one of magnetic attraction, snap-fit connection and hanging mounting. However, it is not limited to at least one of magnetic attraction, snap-fit connection and hanging mounting, and any other non-fastening detachable means are also possible.

Specifically, the camera assembling component 5 comprises a magnetic attraction assembly, which comprises a first magnetic attraction piece 51 and a second magnetic attraction piece 52; the first magnetic attraction piece 51 is arranged on the camera assembly 4, the second magnetic attraction piece 52 is arranged on the feed bin assembly 1, and the first magnetic attraction piece 51 and the second magnetic attraction piece 52 are fixed via mutual magnetic attraction. Quick connection and positioning are realized through the fixation of the first magnetic attraction piece 51 and the second magnetic attraction piece 52 via magnetic attraction, and the attraction force of the first magnetic attraction piece 51 and the second magnetic attraction piece 52 can realize the autonomous guidance of the camera assembly 4 during the installation of the camera assembly 4, without the need of manual auxiliary positioning, thus improving the convenience of the installation of the camera assembly 4.

Further speaking, one of the first magnetic attraction piece 51 and the second magnetic attraction piece 52 is provided with a limiting slot (not shown), the other is provided with a limiting lug (not shown), and the limiting lug is accommodated in the limiting slot. Illustratively, the first magnetic attraction piece 51 is provided with a limiting slot, and the second magnetic attraction piece 52 is provided with a limiting lug correspondingly. When the first magnetic attraction piece 51 and the second magnetic attraction piece 52 are fixed via mutual magnetic attraction, the limiting lug is accommodated in the limiting slot, and the cooperation of the limiting lug and the limiting slot limits the camera assembly 4 in the direction perpendicular to the attraction direction, so as to prevent the camera assembly 4 from generating unexpected displacement in the direction perpendicular to the attraction direction.

As shall be appreciated, at least one of the first magnetic attraction piece 51 and the second magnetic attraction piece 52 is magnetic in order to ensure the generation of magnetic attraction between the first magnetic attraction piece 51 and the second magnetic attraction piece 52.

Specifically, in some embodiments, one of the first magnetic attraction piece 51 and the second magnetic attraction piece 52 is metal, and the other is a magnetic member. Illustratively, the first magnetic attraction piece 51 is metal and the second magnetic attraction piece 52 is a magnetic member. By preferably providing the first magnetic attraction piece 51 as metal, it can effectively prevent the occurrence of erroneous attraction caused by the camera assembly 4 (which has the first magnetic attraction piece 51 set as a magnetic member) accidentally touching other metal parts during its installation. Moreover, having only one of the first magnetic attraction piece 51 and the second magnetic attraction piece 52 as a magnetic member reduces the production cost of the bird feeder 1000.

Alternatively, in some other embodiments, the first magnetic attraction piece 51 and the second magnetic attraction piece 52 are both magnetic members with the opposite magnetic polarities. Through the above arrangement, both the first magnetic attraction piece 51 and the second magnetic attraction piece 52 generate a mutual magnetic attraction force, which is obviously stronger than that generated between the first magnetic attraction piece 51 and the second magnetic attraction piece 52 when one is a magnetic member and the other is a metal, thereby ensuring stable connection between the camera assembly 4 and the feed bin assembly 1.

In some embodiments, referring to FIG. 1 and FIG. 6, the camera assembling component 5 further comprises a snap-fit assembly 53, which is arranged on the feed bin assembly 1 and used for securing the camera assembly 4 via snap-fit connection. The quick and stable disassembly and assembly as well as position limiting of the camera assembly 4 are realized by snap-fit connection.

Specifically, the snap-fit assembly 53 comprises two elastic snap-fit members 531, both of which are fixed to the feed bin assembly 1, and the two elastic snap-fit members 531 are spaced apart from each other to form a snap-fit groove (not labeled) for accommodating the camera assembly 4, and the two elastic snap-fit members 531 are used for clamping the camera assembly 4. Further speaking, the elastic snap-fit member 531 comprises a mounting arm 5311, a connecting arm 5312 and an elastic arm 5313, one end of the connecting arm 5312 is fixed to the mounting arm 5311, and the other end of the connecting arm 5312 is fixed to the elastic arm 5313. The elastic arm 5313 is used for providing an elastic force to abut against the camera assembly 4, and one end of the elastic arm 5313 away from the connecting arm 5312 is bent to form a retaining groove 5313a. The mounting arm 5311 is fixed to the feed bin assembly 1, the retaining grooves 5313a of the two elastic arms 5313 are arranged opposite to each other to form the above-mentioned snap-fit grooves, and the retaining grooves 5313a of the two elastic arms 5313 are used for accommodating the camera assembly 4. When the two elastic snap-fit members 531 are in a natural state, that is, when the camera assembly 4 is not accommodated in the snap-fit groove, the spacing between the elastic arms 5313 of the two elastic snap-fit members 531 is the reserved spacing during installation. When the two elastic snap-fit members 531 are in a compressed state, that is, when the camera assembly 4 is secured in the snap-fit groove, the elastic arms 5313 of the two elastic snap-fit members 531 are elastically deformed, so that the spacing between the elastic arms 5313 of the two elastic snap-fit members 531 is increased and thus the elastic arms 5313 press or hold the camera assembly 4.

In some embodiments, referring back to FIG. 6, in order to make it convenient to secure the camera assembly 4 in the above-mentioned snap-fit groove, the elastic snap-fit member 531 further comprises a guiding arm 5314 which is arranged at one end of the elastic arm 5313 away from the connecting arm 5312. The distance between the guiding arms 5314 of the two elastic snap-fit members 531 gradually increases along the direction from the connecting arm 5312 to the elastic arm 5313, the guiding arms 5314 are used to direct the camera assembly 4 into the retaining groove 5313a, and the two gradually increasing guiding arms 5314 form a ramp-like sliding surface (not labeled), which facilitates the sliding guidance of the camera assembly 4 into the retaining groove 5313a.

It should be noted that the camera assembling component 5 of the bird feeder 1000 includes, but is not limited to, any one or a combination of the above-mentioned snap-fit assembly 53, and first and second magnetic attraction pieces 51 and 52. In some embodiments, the camera assembling component 5 is a combination of the snap-fit assembly 53 and the first magnetic attraction piece 51 and the second magnetic attraction piece 52, and the direction in which the camera assembly 4 is secured to the snap-fit assembly 53 is perpendicular to the direction in which the camera assembly 4 is fixed by the mutual magnetic attraction of the first magnetic attraction piece 51 and the second magnetic attraction piece 52, thus forming a triangle-like stable fixing structure for the camera assembly 4.

In some embodiments, referring back to FIG. 1, in order to reasonably plan the functional areas in the bird feeder 1000, and to ensure that birds eating on the feeding trough 21 or perching on the perch assembly 3 can be visually observed within the shooting range of the camera assembly 4, the selection of the height of the installation groove 115 relative to the whole bird feeder needs to allow the camera assembly 4 arranged in the installation groove 115 to clearly capture the frontal feeding images of birds, and the specific height data will not be illustrated one by one in this embodiment.

Referring to FIG. 1, the bin body 11 comprises an inner frame body 116, and the inner frame body 116 forms the installation groove 115 described above. Specifically, the snap-fit assembly 53 is installed on the inner surface of the back panel of the inner frame body 116, and the second magnetic attraction piece 52 is installed on the inner surface of the peripheral panel of the inner frame body 116, so that the direction in which the camera assembly 4 is secured on the snap-fit assembly 53 is perpendicular to the direction in which the camera assembly 4 is fixed by the mutual magnetic attraction between the first magnetic attraction piece 51 and the second magnetic attraction piece 52.

With the arrangement of the camera assembling component 5, when a user needs to assemble the camera assembly 4, he/she only needs to bring the first magnetic attraction piece 51 and the second magnetic attraction piece 52 into magnetic contact, and then press the camera assembly 4 into the snap-fit assembly 53 to complete the assembly. When the camera assembly 4 needs to be removed, the user only needs to pull out the camera assembly 4 in the opposite direction or press to release the magnetic attraction, which is simple and convenient without the need of any tools.

The camera assembly 4 is a tool that needs to capture images regularly or in real time, and thus the power source of the camera assembly 4 is usually provided by the battery built therein. However, the capacity of the battery built in the camera assembly 4 is limited and cannot support prolonged operation of the camera assembly 4. In order to recharge the battery of the camera assembly 4 in time, in some embodiments, referring to FIG. 1, the bird feeder 1000 comprises a power supply assembly 6 for supplying power to the camera assembly 4. The power supply assembly 6 is connected with the camera assembly 4 to directly supply power to the camera assembly 4 or to recharge the battery built in the camera assembly 4.

As shall be appreciated, the power supply assembly 6 may be directly arranged in the feed bin assembly 1 or arranged independently. The power supply assembly 6 is electrically connected to the camera assembly 4 through a wire 61. The power supply assembly 6 includes, but is not limited to, a solar panel 6a, a wind driven generator or the like.

In some embodiments, considering the integrity, portability and convenience of the bird feeder 1000, referring to FIG. 1 and FIG. 7, the power supply assembly 6 is a solar panel 6a, and the solar panel 6a is arranged on the feed bin assembly 1 and connected with the camera assembly 4. The solar panel 6a is small in size, which is convenient to be integrated into the bird feeder 1000. Moreover, the solar panel 6a relies on solar energy to generate electricity, so it belongs to clean energy and ensures the compatibility of the bird feeder 1000 with the external environment. Considering the installation mode of the bird feeder 1000 and the maximum duration and area for light energy absorption, the solar panel 6a is installed on the top of the bird feeder 1000.

Further speaking, the outer surface of the feed bin assembly 1 is provided with an accommodating groove 14, the solar panel 6a is installed in the accommodating groove 14, and the front face of the solar panel 6a facing away from the accommodating groove 14 (i.e., the side that absorbs light energy) is flush with the outer surface of the feed bin assembly 1. The solar panel 6a and the feed bin assembly 1 are formed into an integrated structure by the arrangement of the accommodating groove 14.

Meanwhile, in order to prevent rainwater or the like from entering between the solar panel 6a and the accommodating groove 14 and damaging the solar panel 6a, the solar panel 6a is hermetically installed in the accommodating groove 14. Specifically, when the solar panel 6a is installed in the accommodating groove 14, the gap between the solar panel 6a and the accommodating groove 14 is sealed. The sealing may be achieved by sealant filling or covering or the like.

As shall be appreciated, for the integrated structure where the solar panel 6a is accommodated in the feed bin assembly 1 through the accommodating groove 14, the accommodating groove 14 is processed in various ways for the feed bin assembly 1, and the processing method for the accommodating groove 14 varies depending on the materials of the feed bin assembly 1. Illustratively, when the feed bin assembly 1 is made of plastics, the accommodating groove 14 is processed by injection molding; and when the feed bin assembly 1 is made of metals, the accommodating groove 14 is manufactured by stamping and molding.

In some embodiments, referring to FIG. 1, the feed bin assembly 1 is provided with a first wire through hole 141 at the bottom of the accommodating groove 14, and the first wire through hole 141 is communicated with the accommodating groove 14. The power supply assembly 6 further comprises a wire 61, one end of the wire 61 is connected with the camera assembly 4, and the other end of the wire 61 may pass through the first wire through hole 141 and then connect with the solar panel 6a. The arrangement of the aforesaid first wire through hole 141 is convenient for the wire 61 to be accommodated in the feed bin assembly 1, so as to improve the integration and neatness of the power supply assembly 6 and the feed bin assembly 1. Moreover, by accommodating the wire 61 in the feed bin assembly 1, it can effectively prevent animals such as rats and squirrels from biting the wire 61, and also improve the neatness and aesthetics of the bird feeder 1000.

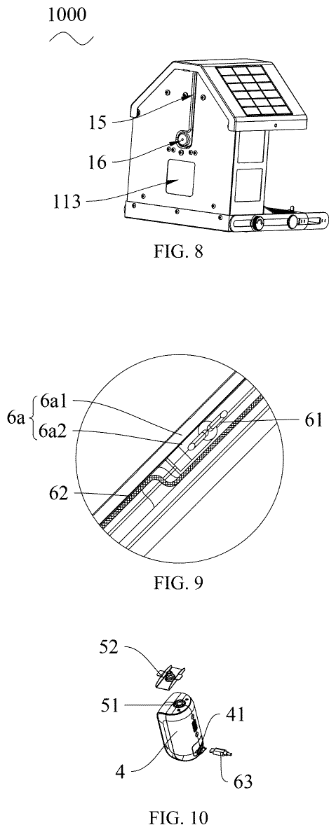

In some embodiments, referring to FIG. 8, the feed bin assembly 1 is provided with a wire duct 15 on the outer side of the back panel facing away from the camera assembly 4, the back panel of the feed bin assembly 1 is further provided with a second wire through hole 16 which is communicated with the wire duct 15, the wire 61 is accommodated in the wire duct 15, and one end of the wire 61 may pass through the second wire through hole 16 to connect with the camera assembly 4. The arrangement of the wire duct 15 facilitates the routing, concealment and protection of the wire 61 between the camera assembly 4 and the power supply assembly 6, avoids external impacts and effectively prevents animals such as rats and squirrels from biting the wire 61 and thus damaging the wire 61.

In some embodiments, a waterproof cap (not labeled) is arranged at the second wire through hole 16, the inner ring of the waterproof cap is arranged around the wire 61, and the outer ring of the waterproof cap abuts against the inner wall of the second wire through hole 16, thus realizing the waterproof function at the second wire through hole 16 and preventing external water from entering the feed bin assembly 1 through the gap between the wire 61 and the inner wall of the second wire through hole 16.

In some embodiments, referring back to FIG. 1, the feed bin assembly 1 is provided with a plurality of retaining hooks 17, and the plurality of retaining hooks 17 are used for securing the wire 61 so as to restrict the arrangement of the wire 61 between the accommodating groove 14 and the wire duct 15.

As shall be appreciated, the layout of the retaining hooks 17 is set according to the actual routing of the wire 61, so as to make the layout of the wire 61 in the accommodating cavity more reasonable and improve the aesthetics of the layout of the wire 61. Illustratively, a retaining hook 17 is arranged at the end of the wire duct 15 away from the second wire through hole 16, so as to facilitate the turning of the wire 61 at the end of the wire duct 15.

The solar panel 6a needs to receive solar rays for conversion, and also needs to perform rectification and control on the current generated by conversion. Therefore, the structure of the solar panel 6a is complex with numerous components, and a lot of heat will be generated during the conversion process. If the heat cannot be dissipated in time, the conversion efficiency and service life of the solar panel 6a will be greatly compromised. Metal provides good heat conduction and dissipation characteristics.

Therefore, in some embodiments, referring back to FIG. 1 and FIG. 7, the feed bin assembly 1 is made of metal, and the back of the panel body 6al of the solar panel 6a is connected with the metal feed bin assembly 1 either directly or via a thermally conductive element provided therebetween. Furthermore, the panel body 6al is installed in the accommodating groove 14. The panel body 6al of the solar panel 6a is directly installed on the metal feed bin assembly 1, instead of assembling the panel body 6al in a plastic outer frame first and then installing the plastic outer frame on the feed bin assembly 1. In this way, heat conduction is performed directly between the back of the panel body 6al of the solar panel 6a and the metal feed bin assembly 1 or via a thermally conductive element provided therebetween, which greatly improves the heat dissipation effect of the solar panel 6a and ensures the performance of the solar panel 6a.

Further speaking, the solar panel 6a further comprises a controller 6a2, and the controller 6a2 is connected with the panel body 6a1. The bottom of the accommodating groove 14 is also provided with an avoidance groove 142. The first wire through hole 141 communicates with the bottom of the avoidance groove 142. When the panel body 6al is accommodated in the accommodation groove 14, the controller 6a2 is accommodated in the avoidance groove 142, and the other end of the wire 61 is connected to the controller 6a2 after passing through the first wire through hole 141. With the arrangement of the avoidance groove 142, all components of the solar panel 6a can be accommodated and concealed, thereby improving the integration and neatness of the solar panel 6a and the feed bin assembly 1, avoiding the messy layout of the power supply assembly 6, and improving the aesthetics of the solar panel 6a accommodated in the accommodation groove 14.

In some embodiments, referring to FIG. 9, the power supply assembly 6 further comprises a thermally conductive adhesive layer 62 that is disposed between the back surface of the panel body 6al and the bottom of the accommodating groove 14. One surface of the thermally conductive adhesive layer 62 is connected with the back surface of the panel body 6al, and the other surface of the thermally conductive adhesive layer 62 is connected with the bottom of the accommodating groove 14, so as to improve the heat conduction efficiency between the back surface of the panel body 6al of the solar panel 6a and the bottom of the accommodating groove 14, and at the same time, enhance the waterproofness between the panel body 6al and the bottom of the accommodating groove 14. Moreover, it facilitates the rapid and uniform transfer of heat of the panel body 6al in the working state to the feed bin assembly 1, thus ensuring the working stability of the power supply assembly 6.

As shall be appreciated, the thermally conductive adhesive layer 62 includes, but is not limited to, thermally conductive gel, single/two-component epoxy thermally conductive adhesive, neutral single-component room-temperature moisture-curing silicone rubber or the like.

In some embodiments, referring to FIG. 10, the power supply assembly 6 further comprises a first connector 63 which is arranged on the feed bin assembly 1, and one end of the wire 61 is connected with the first connector 63. The camera assembly 4 is provided with a second connector 41 which is used for plug-in connection with the first connector 63. The first connector 63 and the second connector 41 realize the electrical connection between the power supply assembly 6 and the camera assembly 4, and the cooperation of the first connector 63 and the second connector 41 enables the formation of a new fixing point at the connection position of the first connector 63 and the second connector 41 when the camera assembly 4 is accommodated in the installation groove 115, thereby improving the stability of the camera assembly 4 fixed to the feed bin assembly 1.

In some embodiments, a sealing member (not labeled) is provided at the connection position between the first connector 63 and the second connector 41. When the first connector 63 is engaged with the second connector 41, the first connector 63 and the second connector 41 abut against the sealing member, thus improving the waterproof property of the connection between the camera assembly 4 and the power supply assembly 6.

For the above-mentioned feed bin assembly 1, referring back to FIG. 1, the feed bin assembly 1 comprises a bin body 11 and a top cover 19. The top cover 19 is arranged at the upper end of the bin body 11, and it covers at least part of the bin body 11 and the feeding trough 21, so that the top cover 19 protects at least part of the bin body 11, the camera assembly 4 and the feeding trough 21. When it is raining outside, the top cover 19 blocks the external rain, prevents the camera assembly 4 from being interfered with by the rain, and protects the bird feed from moisture and spoilage.

In order to facilitate the opening and closing of the top cover 19 and thus make it convenient for the user to replenish bird feed into the feed cavity 111 of the bin body 11, the top cover 19 is rotatably installed at the upper end of the bin body 11, and the bin body 11 is opened or closed by rotating the top cover. Furthermore, when the top cover 19 rotates in the direction away from the upper end of the bin body 11, the bin body 11 is gradually opened, and when the top cover 19 rotates in the direction near the upper end of the bin body 11, the bin body 11 is gradually closed.

Specifically, the feed bin assembly 1 further comprises a top cover connector for rotatably mounting the top cover 19 on the upper end of the bin body 11. In one mode, the top cover connector comprises a rotating connector 191 and a stabilizing connector 192. The rotating connector 191 comprises a rotating shaft 1911 and a rotating sleeve 1912, which are respectively installed on the bin body 11 and the top cover 19. Optionally, the rotating shaft 1911 is installed on the top cover 19, and the rotating sleeve 1912 is installed on the bin body 11. Further speaking, the rotating sleeve 1912 has a guide groove with a preset length, and the rotating shaft 1911 can move along the guide groove, so that the top cover 19 can not only rotate under the restriction of the rotating sleeve 1912, but also move along the guide groove so as to regulate the flexibility of the arrangement of the top cover 19 at the upper end of the bin body 11. The stabilizing connector 192 is used to stably connect the top cover 19 with the bin body 11, and prevent the top cover 19 from being accidentally opened when it is covered at the upper end of the bin body 11. The stabilizing connector 192 may function by magnetic attraction, snap-fit connection, buckle connection or the like, which can provide both stable connection and rapid engagement/disengagement. Preferably, when the top cover 19 and the bin body 11 are made of metal, the stabilizing connector 192 functions by magnetic attraction and it includes a magnetic connector which may be arranged on at least one of the top cover 19 and the bin body 11. When the top cover 19 is displaced in the direction of getting rid of the magnetic attraction in the guide groove, the magnetic attraction between the top cover 19 and the bin body 11 can be released. When the top cover 19 is displaced in the direction of magnetic attraction in the guide groove, the top cover 19 and the bin body 11 can be stably connected by magnetic attraction, so that the top cover 19 can simply and quickly open and close the bin body 11.

Further speaking, the power supply assembly 6 is arranged on the outer surface of the top cover 19, and the accommodating groove 14 is also arranged on the outer surface of the top cover 19, so as to improve the integration of the power supply assembly 6 fixed to the feed bin assembly 1. The top cover 19 may take various shapes such as a V-shape, an arc shape, a plane shape or the like. At least one power supply assembly 6 may be provided on the top cover 19.

As shall be appreciated, in order to prevent bird feed in the feeding trough 21 from getting wet by rain, the part of the feeding trough 21 shielded by the top cover 19 should correspond to the entire feeding trough 21, or the shielding area of the top cover 19 should extend beyond the feeding trough 21 until it covers the perch assembly 3, thereby providing birds with shelter from sun or rain while perching on the perch assembly 3.

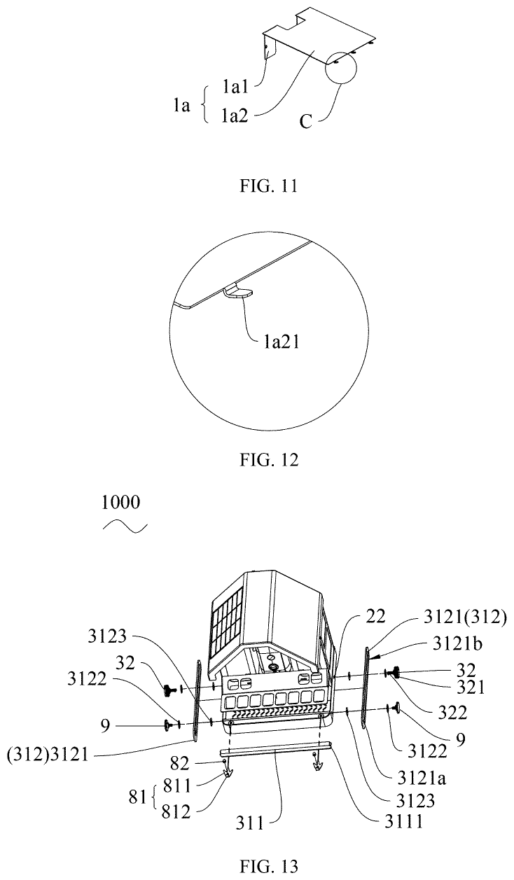

In some embodiments, referring to FIG. 1 and FIG. 11, the feeding trough 21 protrudes at least partially from the feed bin assembly 1 in the direction perpendicular to the direction from the upper end to the lower end of the feed bin assembly 1, so that the area of the feeding trough 21 protruding from the feed bin assembly 1 constitutes a feeding zone, which is convenient for birds to eat in the feeding zone. The feed bin assembly 1 further comprises a material guide 1a which is obliquely arranged at the feed outlet 112, and the material guide 1a is used for guiding the feed in the feed cavity 111 to the part of the feeding trough 21 protruding from the feed bin assembly 1.

As shall be appreciated, the inclination angle of the material guide 1a arranged at the feed outlet 112 needs to be selected according to the actual needs, such as the particle size and shape of the bird feed. When the particles of bird feed are large and the shapes of bird feed are irregular, the inclination angle of the material guide 1a is increased to ensure the smooth feed discharge of the bird feeder. When the particles of bird feed are small and the shapes of bird feed are regular, the inclination angle of the material guide 1a is reduced to control the amount of feed output of the bird feeder. Specific angle selection will not illustrated one by one in this embodiment.

It should be noted that the ways in which the material guide 1a is arranged at the feed outlet 112 include but are not limited to screw fastening, snap-fit connection, riveting, welding, adhesive bonding or the like.

In this embodiment, referring to FIG. 11 and FIG. 12, preferably, the material guide 1a is fixed to the feed outlet 112 by riveting in combination with inserting, wherein one part of the material guide 1a is accommodated in the feeding trough 21, and the other part of the material guide 1a is accommodated in the feed cavity 111. Specifically, the bird feeder 1000 comprises several connectors (not labeled). The material guide 1a comprises a supporting part 1a1 and an inclined part 1a2, one end of the supporting part 1a1 abuts against the bottom of the feeding trough 21, and the other end of the supporting part 1a1 is connected with the inclined part 1a2. One portion of the supporting part 1a1 is accommodated in the feeding trough 21, the other portion of the supporting part 1a1 is accommodated in the feed cavity 111, and the other end of the inclined part 1a2 abuts against the bottom of the feeding trough 21. Further speaking, in order to avoid the unexpected displacement of the material guide 1a in the feeding trough 21, the other end of the inclined part 1a2 is provided with a plug-in part 1a21 at the end thereof, and a plug-in hole is correspondingly arranged in the feeding trough 21, and the plug-in part 1a21 is inserted into the plug-in hole. The supporting part 1a1 is provided with a plurality of first fixing holes, and both the side wall of the feeding trough 21 and the side wall of the metal bin body 11 are provided with a plurality of second fixing holes. Part of the connectors sequentially pass through the second fixing holes arranged on the side wall of the feeding trough 21, the first fixing holes, part of the second fixing holes arranged on the side of the metal bin body 11 and part of the first fixing holes to fixedly connect the feeding tray assembly 2, the metal bin body 11 and the supporting part 1a1 accommodated in the feeding trough 21. Another part of the connectors sequentially pass through another part of the second fixing holes arranged at the side of the metal bin body 11 and another part of the first fixing holes to fixedly connect the metal bin body 11 with the supporting part 1a1 accommodated in the feed cavity 111. By the cooperation of the aforesaid plurality of first fixing holes, the plurality of second fixing holes arranged at the side wall of the feeding trough 21 and the plurality of second fixing holes arranged at the side wall of the metal bin body 11 with the connectors, tight connection between the material guide 1a and the feed bin assembly 1 and the feeding tray assembly 2 is realized, and the supporting part 1a1 of the material guide 1a also serves as a reinforcing plate-like structure for connecting the feed bin assembly 1 and the feeding tray assembly 2, thus improving the overall structural strength of the bird feeder 1000.

It should be noted that in the assembly process of the feed bin assembly 1 and the feeding tray assembly 2, there is a common area between a part of the feed cavity 111 and the feeding trough 21, and the part of the material guide 1a in this common area means the part of the material guide 1a that is accommodated in the feeding trough 21, and further means that the supporting part 1a1 in this common area is the part accommodated in the feeding trough 21.

In some embodiments, the material guide 1a may also be provided with an avoidance cavity (not labeled) for accommodating a part of the inner frame body 116, so as to make the structure of the bird feeder 1000 more compact, reduce the volume of the bird feeder 1000, and improve the integration of the bird feeder 1000.

The above-mentioned perch assembly 3 and the rod-like structure 31 that should be provided in the perch assembly 3 will be illustrated herein. Referring to FIG. 13, the perch assembly 3 is provided with a standing rod 311 which may be directly fixed on the feeding tray assembly 2 for birds to stand on. Alternatively, a distance adjusting member 312 is provided, which is connected to the standing rod 311 and the feeding tray assembly 2 to adjust the distance between the standing rod 311 and the feeding tray assembly 2, so that the spacing between the standing rod 311 and the feeding tray assembly 2 can be adjusted to adapt to birds of different sizes.

As shall be appreciated, the distance adjusting member 312 may be manually adjusted, or a corresponding driver and connecting rod may be set to realize automatic adjustment, and the automatic adjustment may be performed by comparing the local database and the database stored in the cloud with the bird pictures taken by the camera assembly 4, so as to realize intelligent adjustment for different types of birds.

It should be noted that the distance adjusting member 312 adjust the distance by means including but not limited to a telescopic rod, a folding rod or a sliding rod or any structure that can realize distance adjustment. Illustratively, the distance adjusting member is a telescopic rod or a folding rod.

Alternatively, in some embodiments, referring to FIG. 13, the distance adjusting member 312 uses a sliding rod to realize distance adjustment. Specifically, the distance adjusting member 312 comprises a connecting rod 3121, one end of the connecting rod 3121 is connected with the standing rod 311, and the connecting rod 3121 is slidably arranged on the feeding tray assembly 2, so that the connecting rod 3121 is connected with the feeding tray assembly 2. The perch assembly 3 further comprises a locking piece 32 detachably mounted on the feeding tray assembly 2, and the locking piece 32 is connected with the connecting rod 3121. The locking piece 32 is used for fixing the connecting rod 3121 to or unlocking the connecting rod 3121 from the feeding tray assembly 2, and the connecting rod 3121 can slide to adjust the distance between the standing rod 311 and the feeding tray assembly 2 when unlocked.

In some embodiments, referring to FIG. 13, the locking piece 32 is provided with anti-slip textures 321, so as to increase the frictional force during manual adjustment by user, reduce the operational difficulty for users, and avoid the case where the adjustment is hard to be performed because the outer surface of the locking piece 32 is too smooth or wet by rain.

As shall be appreciated, the ways of connecting the standing rod 311 with the connecting rod 3121 include, but not limited to, integral molding, detachable fixing or the like. Illustratively, the standing rod 311 and the connecting rod 3121 are detachably fixed. Specifically, both ends of the standing rod 311 are provided with engagement lugs 3111, and the connecting rod 3121 is provided with engagement slots 3121a, and the engagement lugs 3111 are engaged with the engagement slots 3121a to form a connection mode in which the engagement lugs 3111 and the engagement slots 3121a are engaged with each other via snap-fit connection. Such a fixing mode for the engagement lugs 3111 and the engagement slots 3121a is convenient for the maintenance and replacement of the standing rod 311. When the standing rod 311 or the connecting rod 3121 is damaged, only the damaged part needs to be replaced separately, which reduces the maintenance cost of the bird feeder 1000.

Furthermore, the connecting rod 3121 is provided with a sliding slot 3121b, and the locking piece 32 is connected with the feeding tray assembly 2 after passing through the sliding slot 3121b, so as to realize position limiting of the connecting rod 3121. Moreover, the sliding travel of the connecting rod 3121 is limited by the cooperation of the locking piece 32 and the sliding slot 3121b.

As shall be appreciated, the means for connecting the locking piece 32 and the feeding tray assembly 2 include, but not limited to, welding, screw fastening, snap-fit connection, and mortise-and-tenon connection or the like. Illustratively, in some embodiments, one end of the locking piece 32 close to the feeding tray assembly 2 is provided with a threaded part 322, the feeding tray assembly 2 is provided with a threaded groove 22, and the locking piece 32 is threaded into the threaded groove 22 after passing through the sliding slot 3121b.

In some embodiments, referring to FIG. 13, the bird feeder 1000 further comprises a guiding member 9, which is installed on the feeding tray assembly 2. At least part of the guiding member 9 passes through the sliding slot 3121b, the guiding member 9 is spaced apart from the locking piece 32, the connecting rod 3121 can slide relative to the guiding member 9, and the guiding member 9 cooperates with the locking piece 32 to guide the sliding direction of the connecting rod 3121. Furthermore, the guiding member 9 and the locking piece 32 also collectively restrain the connecting rod 3121, and prevent the connecting rod 3121 from rotating around the locking piece 32 during its sliding motion. Further speaking, the guiding member 9 and the locking piece 32 have different sizes or shapes so as to visually distinguish their functions, which is convenient for users to distinguish the guiding member 9 from the locking piece 32 by directly observing the appearances thereof.

When a bird stands on the standing rod 311 of the perch assembly 3, an instantaneous impact force will be exerted on the standing rod 311 during takeoff or landing of the bird, and the connection position between the locking piece 32 and the feeding tray assembly 2 will become loose when it is subjected to such force for a long time. Therefore, in some embodiments, the distance adjusting member 312 comprises a first gasket 3122 and a second gasket 3123, the first gasket 3122 is located at the side of the connecting rod 3121 facing away from the feeding tray assembly 2, and the locking piece 32 passes through the first gasket 3122. The second gasket 3123 is located between the connecting rod 3121 and the feeding tray assembly 2, and the locking piece 32 passes through the second gasket 3123. With the additional arrangement of the first gasket 3122, the contact area between the locking piece 32 and the connecting rod 3121 is increased, so that the contact area of the locking piece 32 for the fixing operation is improved, the stability of the locking piece 32 for fixing is enhanced, and the fixing failure of the locking piece 32 due to the vibration caused by the impact when birds take off or land is prevented. With the additional arrangement of the second gasket 3123, the contact surface between the connecting rod 3121 and the feeding tray assembly 2 is isolated and protected, so that direct contact between the connecting rod 3121 and the feeding tray assembly 2 is avoided, and scratches to the contact surface between the connecting rod 3121 and the feeding tray assembly 2 caused by the fixing of the locking piece 32 is prevented. Moreover, the arrangement of the second gasket 3123 ensures the retention of the sliding gap between the connecting rod 3121 and the feeding tray assembly 2 during sliding, and avoids the local deformation of the connecting rod 3121 due to the locking operation of the locking piece 32, which otherwise would affect the sliding of the connecting rod 3121.

During the actual use, the bird feeder 1000 is placed in the outdoor environment, and the perch assembly 3 may be directly exposed to sunlight. Under the prolonged direct sunlight exposure, the temperature of the standing rod 311 of the perch assembly 3 will increase due to heat absorption, which might scald the toes of birds.

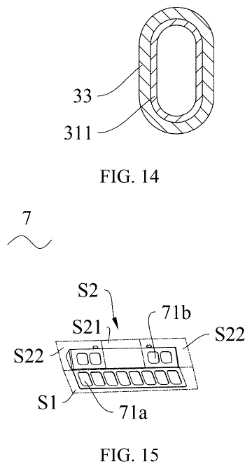

In some embodiments, referring to FIG. 14, the perch assembly 3 further comprises a thermal insulation member 33, which is sleeved on the standing rod 311 to form an anti-scalding layer on the standing rod 311 so as to prevent the toes of birds from being scalded.

As shall be appreciated, the thermal insulation member 33 wraps part or all of the outer surface of the standing rod 311. Illustratively, the part of the standing rod 311 that is wrapped is the area which is more likely to be grasped by the birds on the standing rod 311. Alternatively, the entire outer surface of the standing rod 311 is wrapped to form a comprehensive protection for the toes of birds.

As shall be appreciated, the ways in which the thermal insulation member 33 is sleeved on the standing rod 311 include, but not limited to, being detachably sleeved on the standing rod 311 or being directly wrapped on the standing rod 311. In this embodiment, it is preferable that the thermal insulation member 33 is detachably sleeved on the standing rod 311, so that the thermal insulation member 33 can be easily replaced by the user after being damaged or aged.

In some embodiments, the outer surface of the thermal insulation member 33 is provided with anti-skid patterns (not labeled) to increase the frictional force between the toes of the birds and the standing rod 311 when the birds grasp the standing rod 311 with their toes, so as to ensure the stability of the bird when standing on the standing rod 311.

It shall be noted that the perch assembly 3 comprises a standing rod 311 made of metal materials and a thermal insulation member 33 made of non-metallic materials. The non-metallic materials ensure the excellent thermal insulation performance of the thermal insulation member 33, wherein the non-metallic materials include but are not limited to aerogel materials, high-performance polymer materials, high-temperature resistant fiber materials, silicate materials, ceramic materials and the like.

In some embodiments, referring to FIG. 1, FIG. 13 and FIG. 15, the bird feeder 1000 further comprises an anti-leakage net 7 that is arranged on the feeding tray assembly 2, and the anti-leakage net 7 covers the opening of the feeding trough 21. Furthermore, the anti-leakage net 7 is at least partially accommodated in the feeding trough 21 and covers the opening of the feeding trough 21, and the anti-leakage net 7 is used for protecting the opening of the feeding trough 21 to prevent non-bird animals such as squirrels from stealing bird feed.

In some embodiments, referring to FIG. 3, the feed bin assembly 1 is formed with an inward recessed step portion 1b at the opening of the feeding trough 21, and the end of the anti-leakage net 7 far away from the feed bin assembly 1 is supported on the step portion 1b.

During actual use, in order to prevent birds from blocking the camera assembly 4 during eating, or to prevent birds from being too close to the camera assembly 4 which causes the camera assembly 4 to be out of focus and fail to capture images, in some embodiments, corresponding functional areas are formed on the anti-leakage net 7 of the bird feeder 1000. Specifically, the anti-leakage net is formed with a feeding zone S1 for birds to eat and an avoidance zone S2 that prevents birds from perching normally. The avoidance zone S2 is close to the installation groove 115 of the feed bin assembly 1 of the bird feeder 1000, and the feeding zone S1 is far away from the installation groove 115 of the feed bin assembly 1 of the bird feeder 1000. By physically distinguishing the avoidance zone S2 and the feeding zone S1, the accessible feeding range of birds is ensured to be within the pre-planned area, thus providing an appropriate shooting distance for the camera assembly 4.

Specifically, along the shooting direction of the camera assembly 4 of the bird feeder 1000, the range extending forward from the installation groove 115 to the shooting direction by a predetermined distance is all regarded as the avoidance zone S2. As shall be appreciated, the selection of the predetermined distance is determined by the closest focusing distance that can be photographed by the camera assembly 4 selected for the bird feeder 1000, and this will not be further illustrated one by one herein.

In some embodiments, referring to FIG. 15, the feeding zone S1 is provided with at least one first feeding port 71a which is communicated with the feeding trough 21, so that birds can peck bird feed at the first feeding port 71a. Furthermore, the avoidance zone S2 is provided with at least one second feeding port 71b which is communicated with the feeding trough 21, so that birds can peck bird feed at the second feeding port 71b.

As shall be appreciated, the avoidance zone S2 comprises a perch-forbidden zone S21 and an optional zone S22. The perch-forbidden zone S21 is located right in front of the shooting direction of the camera assembly 4 of the bird feeder 1000 to ensure the closest focusing distance that can be photographed by the camera assembly 4. The optional zone S22 is located on both sides of the perch-forbidden zone S21, and the second feeding port 71b is arranged in the optional zone S22 to increase the number of birds that can be fed through the anti-leakage net 7 and ensure the maximum utilization rate of the bird feeder 1000.

In some embodiments, the feeding zone S1 is arranged horizontally, so that when a bird may stand in the feeding zone S1, it can stand in this area stably to eat; while the avoidance zone S2 is arranged obliquely, so as to prevent the bird from standing in this area and causing interference to the shooting operation of the camera assembly 4.

In some embodiments, the material guide 1a is parallel to the avoidance zone S2.

In some embodiments, referring back to FIG. 1, the end of the avoidance zone S2 far away from the feeding zone S1 is provided with a snap-fit portion 72 which is located at one end of the anti-leakage net 7. That is, the snap-fit portion 72 is located at one end of the anti-leakage net 7 facing the bin body 11. The feed bin assembly 1 is provided with a snap-fit hole 1c that is arranged on the front wall of the feed bin assembly 1, and the snap-fit portion is secured into the snap-fit hole 1c.

It shall be noted that the above-mentioned first feeding port 71a and second feeding port 71b both refer to a plurality of leakage holes 71 arranged in the anti-leakage net 7, and the leakage holes 71 are communicated with the feeding trough 21, so that the arrangement of the leakage holes 71 is convenient for birds to penetrate their beaks through the leakage holes 71 into the feeding trough 21 to peck bird feed, and the diameter of the leakage holes 71 may be set according to the beaks of birds that need to be fed. The diameter of the leakage holes 71 is less than or equal to the maximum diameter of the beaks of the birds, so as to prevent birds from passing their heads through the leakage holes 71 and getting trapped in the anti-leakage net 7. Moreover, the selection of the diameter of the leakage holes 71 also realizes preliminary screening of birds that need to be fed.

Further speaking, in order to enhance the effectiveness of the anti-leakage net 7 against non-bird animals such as squirrels, in some embodiments, natural plant alkaloids such as capsaicin are added to the anti-leakage net 7 during processing thereof, the use of natural plant alkaloids ensures the biocompatibility of the bird feeder 1000 in preventing non-bird animals such as squirrels from biting and damaging the anti-leakage net 7, and the use of capsaicin will not cause health problems for non-bird animals such as squirrels. Illustratively, when the material of the anti-leakage net 7 is plastics, substances for preventing animals biting are added in the injection molding process of the anti-leakage net 7, and when the material of the anti-leakage net 7 is metal, the surface layer of the anti-leakage net 7 is coated with paint mixed with substances for preventing animals biting.

When a bird pecks food on the bird feeder 1000, the anti-leakage net 7 is easily driven to move due to the impact of the beak of the bird or when the bird pulls its head away from the anti-leakage net 7, which results in the anti-leakage net 7 being pulled away from the feeding trough 21, so that the anti-leakage net 7 cannot cover the feeding trough 21.

It shall be noted that the above-mentioned feed bin assembly 1 and feeding tray assembly 2 are the most basic components of the bird feeder 1000, so they can be collectively referred to as the bird-feeding body.

In some embodiments, referring to FIG. 3 and FIG. 13, the bird feeder 1000 further comprises a locking assembly 8, and the locking assembly 8 connects the anti-leakage net 7 with the bird-feeding body so as to lock the anti-leakage net 7 to or unlock the anti-leakage net 7 from the bird-feeding body.

In some embodiments, the locking assembly 8 is rotatably arranged on at least one of the feed bin assembly 1 or the feeding tray assembly 2; and the locking assembly 8 has two working states, namely, when the locking assembly 8 rotates to the first position, the anti-leakage net 7 is restricted from leaving the feeding trough 21 and thus is locked; and when the locking assembly 8 rotates to the second position, the restriction on the anti-leakage net 7 is removed and the anti-leakage net 7 is unlocked.

In some embodiments, the locking assembly 8 comprises a locking piece 81 and a mounting piece 82, the locking piece 81 can rotate around the mounting piece 82, and the mounting piece 82 mounts the locking piece 81 on at least one of the feed bin assembly 1 or the feeding tray assembly 2. When the locking piece 81 rotates to the first position, the locking piece 81 restricts the anti-leakage net 7 from leaving the feeding trough 21; and when the locking piece 81 is rotated to the second position, the locking piece 81 releases the restriction on the anti-leakage net 7.

Illustratively, in some embodiments, the locking assembly 8 is rotatably arranged at the end of the feeding tray assembly 2 that is away from the feed bin assembly 1.

Further speaking, the locking piece 81 comprises a locking part 811 and a handle 812, the handle 812 is connected with one end of the locking part 811, the handle 812 is convenient for the user to rotate the locking part 811 to adjust the rotational position of the locking part 811, and the mounting piece 82 penetrates through the locking part 811. When the locking piece 81 rotates to the first position, a part of the locking part 811 overlaps with the leakage anti-leakage net 7; and when the locking part 811 rotates to the second position, the locking part 811 is completely separated from the anti-leakage net 7.

In some embodiments, one end of the handle 812 is connected with the locking part 811, and the other end of the handle 812 extends in the direction away from the locking part 811, so as to form an elongated lever arm structure, thereby reducing the force required by the user to rotate the locking part 811 and improving the user experience of the locking assembly 8.

In some embodiments, the bird feeder 1000 further comprises a hanging assembly (not labeled) arranged on the feed bin assembly 1, the hanging assembly is fixed on a side facing away from the camera assembly 4, and the hanging assembly is used for hanging and securing the bird feeder 1000 onto a support such as a tree.

In this embodiment, the bird feeder 1000 comprises a feed bin assembly 11, a feeding tray assembly 2, a perch assembly 3 and a camera assembly 4. Specifically, the feed bin assembly 11 comprises a metal bin body 11 and a window baffle 12, the metal bin body 11 is provided with a feed cavity 111, a feed outlet 112 and a signal window 113, the feed outlet 112 is communicated with the feed cavity 111, and the window baffle 12 is arranged on the metal bin body 11 for shielding the signal window 113. The feeding tray assembly 2 is fixed to the feed outlet 112 of the feed bin assembly 11 and is provided with a feeding trough 21, and the feed trough 21 is communicated with the feed cavity 111 through the feed outlet 112. The perch assembly 3 is arranged on the feeding tray assembly 2; the camera assembly 4 is arranged on the feed bin assembly 11, and the shooting range of the camera assembly 4 covers at least part of the feeding trough 21 and the perch assembly 3. By opening the signal window 13 on the metal bin body 11 described above and providing the window baffle 12 to shield the signal window 113, the signal of the camera assembly 4 can penetrate through the signal window 113 and the window baffle 12, so that the signal shielding imposed by the metal bin body 11 on the camera assembly 4 is improved. Furthermore, the window baffle 12 is made of a light-transmissive material, which is convenient for users to intuitively observe the remaining amount of bird feed in the feed cavity 111 and the storage state of bird feed, and convenient for users to replenish bird feed or replace spoiled bird feed in time.

It shall be noted that the specification and attached drawings of the present disclosure give embodiments of the present disclosure, but the present disclosure can be realized in many different forms and is not limited to the embodiments described in this specification. These embodiments do not serve as additional restrictions on the contents of the present disclosure, and the purpose of providing these embodiments is to make the understanding of the disclosure of the present disclosure more thorough and comprehensive. Moreover, the above technical features continue to be combined with each other to form various embodiments not listed above, which are all regarded as within the scope recorded in the specification of the present disclosure. Furthermore, improvements or transformations can be made according to the above description by those of ordinary skill in the art, and all these improvements and transformations shall belong to the scope claimed in the appended claims of the present disclosure.

What is claimed is:

1. A bird feeder, comprising: a feed bin assembly, wherein the feed bin assembly comprises a bin body which is a metal bin body, an installation groove for accommodating and assembling a camera assembly is formed in the bin body, and at least one signal window penetrating through the bin body and the installation groove is opened at the part of the bin body where the installation groove is formed.

2. The bird feeder according to claim 1, wherein at least one of a part of the back panel of the bin body that is opposite to the bottom of the installation groove and a part of the bin body surrounding the peripheral surface of the installation groove is provided with the signal window.

3. The bird feeder according to claim 2, wherein the front panel or the side panel of the bin body is provided with the signal window.

4. The bird feeder according to claim 1, wherein the feed bin assembly further comprises a non-metallic light-transmissive or opaque window baffle, and the window baffle is arranged on the bin body to shield the signal window.

5. The bird feeder according to claim 4, wherein the window baffle is installed on the inner wall of the bin body, and the bin body is provided with a fixing member to fix the window baffle to the signal window.

6. The bird feeder according to claim 5, wherein the fixing member comprises a first fixing arm, a bending arm and a second fixing arm, the first fixing arm is fixed on the inner wall of the metal bin body, one end of the bending arm is connected with the first fixing arm, the other end of the bending arm is connected with the second fixing arm, and the first fixing arm, the bending arm and the second fixing arm together form a first fixing slot into which the window baffle is inserted.

7. The bird feeder according to claim 4, wherein the feed bin assembly further comprises a sealing layer, and the sealing layer is arranged between the window baffle and the metal bin body to seal the window baffle and the metal bin body.

8. The bird feeder according to claim 1, further comprising a feeding tray assembly made of metal, wherein the feeding tray assembly is installed at the feed outlet end of the feed bin assembly.

9. The bird feeder according to claim 1, further comprising a camera assembling component; the camera assembling component detachably assembles the camera assembly to the feed bin assembly in a non-fastening manner, and the camera assembling component is arranged on at least one of the feed bin assembly and the camera assembly.

10. The bird feeder according to claim 9, wherein the camera assembling component detachably assembles the camera assembly to the feed bin assembly in a non-fastening manner in at least two dimensions.

11. The bird feeder according to claim 9, wherein the camera assembling component comprises a magnetic attraction assembly including a first magnetic attraction piece and a second magnetic attraction piece, and at least one of the first magnetic attraction piece and the second magnetic attraction piece is magnetic;
and the first magnetic attraction piece is arranged on the camera assembly, the second magnetic attraction piece is arranged on the feed bin assembly, and the first magnetic attraction piece and the second magnetic attraction piece are fixed via mutual magnetic attraction.

12. The bird feeder according to claim 11, wherein
one of the first magnetic attraction piece and the second magnetic attraction piece is provided with a limiting slot, and the other is provided with a limiting lug, and the limiting lug is accommodated in the limiting slot.

13. The bird feeder according to claim 9, wherein
the camera assembling component further comprises a snap-fit assembly, and the snap-fit assembly is arranged on the feed bin assembly and used to clamp the camera assembly for stable position limiting.

14. The bird feeder according to claim 1, further comprising a power supply assembly for supplying power to the camera assembly; and the power supply assembly is directly arranged on the feed bin assembly or independently arranged and electrically connected with the camera assembly.

15. The bird feeder according to claim 14, wherein the power supply assembly is a solar panel, and the back of the panel body of the solar panel is connected with the metal feed bin assembly either directly or via a thermally conductive element provided therebetween.

16. The bird feeder according to claim 8, wherein a feeding trough is provided on the feeding tray assembly, and comprising an anti-leakage net which can be covered on the feeding tray assembly, the anti-leakage net comprising a feeding zone for birds to eat and an avoidance zone that prevents birds from perching normally; wherein the avoidance zone is close to the feed bin assembly, and the feeding zone is far away from the feed bin assembly.

17. The bird feeder according to claim 16, wherein
the feeding zone is arranged horizontally, and the avoidance zone is arranged obliquely.

18. The bird feeder according to claim 1, comprising a perch assembly that is arranged on the feed bin assembly, wherein the perch assembly comprises a standing rod and a thermal insulation member, the standing rod is used for birds to stand on, and the thermal insulation member is sleeved on the standing rod.

19. The bird feeder according to claim 18, further comprising a connecting rod and a feeding tray assembly, wherein the feeding tray assembly is installed at the feed outlet end of the feed bin assembly, the connecting rod connects the standing rod and the feeding tray assembly of the bird feeder, and the connecting rod is a distance-adjustable connecting rod.

20. The bird feeder according to claim 19, wherein
two ends of the standing rod are provided with engagement lugs, the connecting rod is provided with engagement slots, and the engagement lugs are engaged with the engagement slots.
